(19) United States
(12) Patent Application Publication
(10) Pub. No.: US 2021/0093145 A1
(43) Pub. Date: Apr. 1, 2021

(54) ROBOT CLEANER

(71) Applicant: LG ELECTRONICS INC., Seoul (KR)

(72) Inventors: Jonghoon KIM, Seoul (KR); Youngho KIM, Seoul (KR); Gee Young AHN, Seoul (KR)

(21) Appl. No.: 16/994,206

(22) Filed: Aug. 14, 2020

(30) Foreign Application Priority Data
Sep. 26, 2019 (KR) 10-2019-0119158

(51) Int. Cl. A47L 11/40; A47L 11/282

(52) U.S. Cl. CPC A47L 11/4011; A47L 11/282; A47L 11/4058; A47L 11/4038; A47L 11/4066; A47L 2201/04; A47L 11/4002; A47L 11/4061; A47L 2201/06; A47L 11/4072; A47L 11/4069

(57) ABSTRACT

A robot cleaner includes a body, a first rotating plate, a second rotating plate, a first mop, a second mop, a first support wheel, a second support wheel, and a first lower sensor. The first lower sensor is configured to sense a relative distance from a floor. The first lower sensor is located between the first support wheel and the second support wheel, and is located further away from the first rotating plate and the second rotating plate than the first support wheel and the second support wheel. The robot cleaner may move while being supported by the first mop, the second mop, the first support wheel, and the second support wheel, and easily avoid a cliff in which the floor suddenly drops.

### CROSS-REFERENCE TO RELATED APPLICATIONS

This application claims priority under 35 U.S.C. § 119 to Korean Application No. 10-2019-0119158 filed on Sep. 26, 2019, whose entire disclosure is hereby incorporated by reference. This application is related to U.S. application Ser. No. 16/925,763 filed Jul. 10, 2020 (Attorney Docket No. NAM-0036), whose entire disclosure is also hereby incorporated by reference.

### BACKGROUND

### 1. Field

The present disclosure relates to a robot cleaner, and more particularly, to a robot cleaner which includes rotating mops and one or more wheels that may contact a floor.

### 2. Background

A robot cleaner may include a motor, various sensors, and artificial-intelligence technology to clean an area while traveling autonomously. The robot cleaner may be configured, for example, to suction dust through a vacuum, sweep dust, or mop a surface to be cleaned using a mop.

Korean Patent No. 10-1613446 discloses a robot cleaner that includes a main body, a driver, a first rotating member, and a second rotating member. In addition, the robot cleaner includes a first cleaner and a second cleaner made of cloth, a mop, a nonwoven fabric, a brush, or the like. The first cleaner is coupled to a first fixing member of the first rotating member, and the second cleaner is coupled to a second fixing member of the second rotating member. The first cleaner and the second cleaner are rotated by the rotary motion of the first rotating member and the second rotating member and may, thus, remove foreign substances fixed to a floor from the floor through friction with the floor surface. Also, when a frictional force with the floor surface is generated, this frictional force may also be used to move the robot cleaner such that, when the first cleaner and the second cleaner are rotated, cleaning of the floor and movement of the robot cleaner may be performed together. However, the robot cleaner may not appropriately respond to a floor that includes a step or a drop, and the robot cleaner may fall and, thus, be damaged.

Korean Patent Registration No. 10-2000068 discloses a cleaner that includes a mop module having a mop to clean the floor and a collection module to collect foreign substances from a floor. The cleaner includes cliff sensors configured to sense the presence a cliff, and the cliff sensors are provided under the collection module. However, the cliff sensors are provided behind auxiliary wheels, and the auxiliary wheels may interfere with sensing through the cliff sensors or restrict the sensing range of the cliff sensors, particularly when the cleaner moves forwards such that sensing through the cliff sensors may not be properly achieved due to interface from the wheels. For example, when the cleaner turns, the cliff sensors may be unable to detect a cliff before the auxiliary wheels reach and fall down the cliff.

The above references are incorporated by reference herein where appropriate for appropriate teachings of additional or alternative details, features and/or technical background.

### BRIEF DESCRIPTION OF THE DRAWINGS

The embodiments will be described in detail with reference to the following drawings in which like reference numerals refer to like elements wherein:

FIG. 1 is a perspective diagram illustrating a robot cleaner according to an embodiment of the present disclosure;

FIG. 2 is a perspective diagram illustrating the robot cleaner shown in FIG. 1 from which some elements are separated;

FIG. 3 is a rear diagram illustrating the robot cleaner shown in FIG. 1;

FIG. 4 is a rear diagram illustrating the robot cleaner shown in FIG. 3 from which some elements are separated;

FIG. 5A is a bottom diagram illustrating a robot cleaner according to an embodiment of the present disclosure in which a first rotating plate and a second rotating plate are indicated by a dotted line;

FIG. 5B is a cross-sectional diagram schematically illustrating a portion of the robot cleaner according to an embodiment of the present disclosure in which a first lower sensor, a second lower sensor, or a third lower sensor is coupled to a body;

FIGS. 5C and 5D are cross-sectional diagrams, each of which schematically illustrates a portion of a robot cleaner according to an embodiment of the present disclosure in which a first lower sensor, a second lower sensor, or a third lower sensor is coupled to a body;

FIGS. 6A to 6C are diagrams illustrating sensing of a cliff by the first lower sensor during rectilinear movement or turning of the robot cleaner shown in FIG. 5A;

FIGS. 7A and 7B are side diagrams illustrating the robot cleaner shown in FIG. 5A, wherein a lower portion of the robot cleaner is enlarged;

FIGS. 8A and 8B are side diagrams illustrating the robot cleaner shown in FIG. 5A from which some elements are removed, wherein the lower portion of the robot cleaner is enlarged;

FIG. 9A is a bottom diagram illustrating a robot cleaner according to an embodiment of the present disclosure in which a first rotating plate, a second rotating plate, a first actuator, and a second actuator are indicated by a dotted line;

FIGS. 9B and 9C are diagrams illustrating sensing of a cliff by a second lower sensor or a third lower sensor in the robot cleaner shown in FIG. 9A;

FIG. 10 is an exploded perspective diagram illustrating the robot cleaner shown in FIG. 9A;

FIG. 11 is a cross-sectional diagram schematically illustrating a robot cleaner and elements thereof according to an embodiment of the present disclosure; and

FIG. 12 is a diagram illustrating the sizes of the respective elements of the robot cleaner shown in FIGS. 6A to 6C.

### DETAILED DESCRIPTION

Hereinafter, reference will now be made in detail to various embodiments of the present disclosure, examples of which are illustrated in the accompanying drawings. Wherever possible, the same reference numbers will be used throughout the drawings to refer to the same or like parts. In the drawings, an X-axis direction, a Y-axis direction and a Z-axis direction are orthogonal to each other.

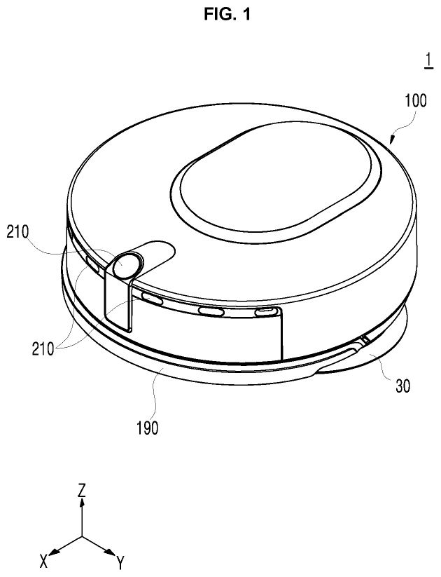

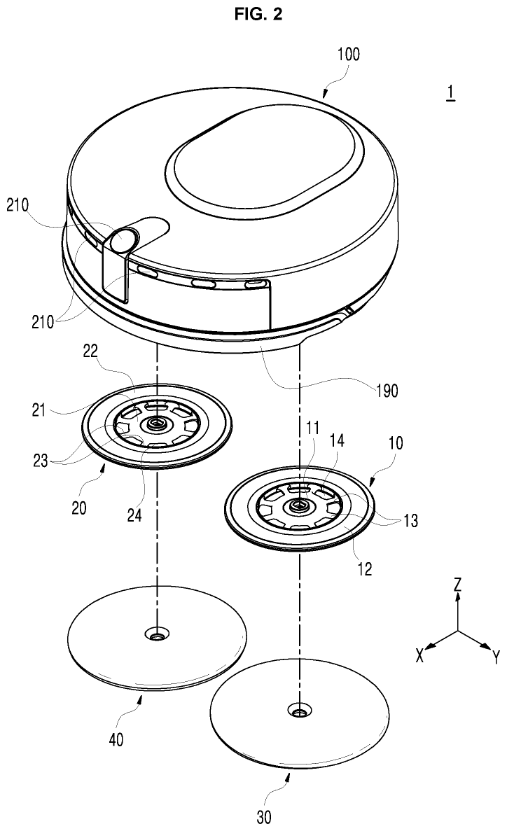

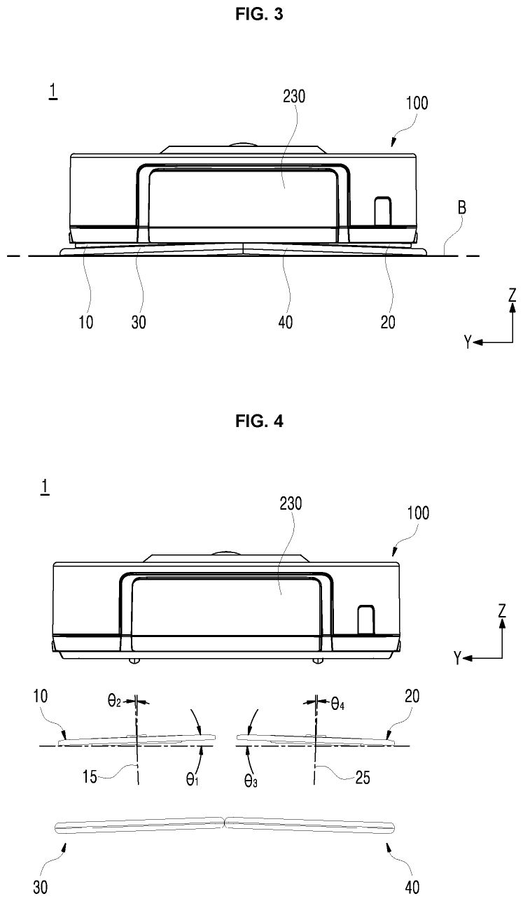

FIG. 1 is a perspective diagram illustrating a robot cleaner 1 according to certain embodiments of the present disclosure. FIG. 2 is a perspective diagram illustrating the robot cleaner 1 shown in FIG. 1 from which some elements are separated. FIG. 3 is a rear diagram illustrating the robot cleaner 1 shown in FIG. 1. FIG. 4 is a rear diagram illustrating the robot cleaner 1 shown in FIG. 3 from which some elements are separated.

The robot cleaner 1 may be placed on a floor and configured to move along a floor surface B so as to clean the floor. Therefore, hereinafter, the vertical direction will be set based on a state in which the robot cleaner 1 is placed on the floor. In addition, a side of the robot cleaner 1 to which first and second support wheels 120 and 130, which will be described below, are coupled may be defined as a “front” side of the robot cleaner 1 relative to a first rotating plate 10 and a second rotating plate 20. In the following description of the embodiments of the present disclosure, ‘the lowermost portion’ or the “lowermost surface” of each element may be a portion at which each element is located at the lowermost position or a portion of each element which is closest to the floor when the robot cleaner is placed on the floor.

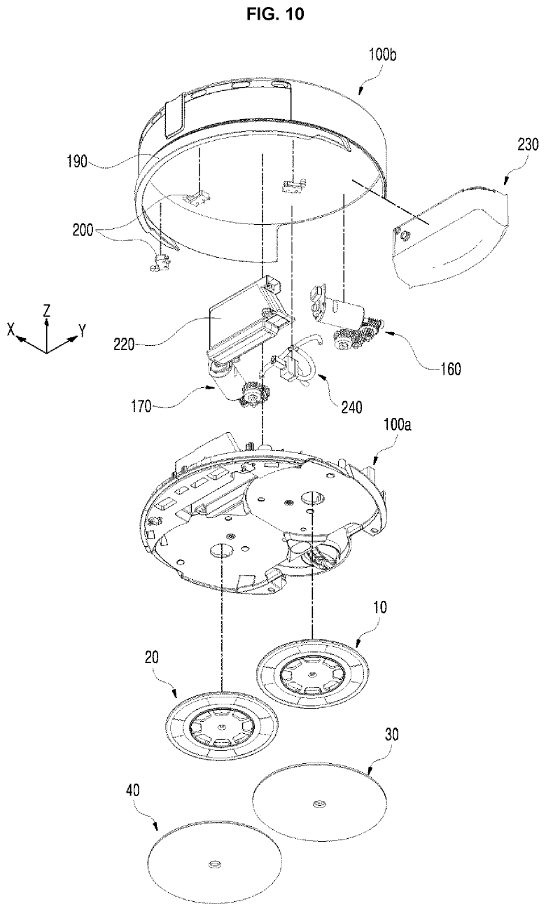

The robot cleaner 1 may include a body 100, the first rotating plate 10, the second rotating plate 20, a first mop 30, and a second mop 40. The body 100 may form the overall exterior of the robot cleaner 1 or be formed as a frame such that additional components are provided on the body to provide an exterior appearance of the robot 1. Respective elements forming the robot cleaner 1 may be coupled to the body 100, and some elements forming the robot cleaner 1 may be accommodated in the body 100. The body 100 may be divided into a lower body 100a and an upper body 100b, and the elements of the robot cleaner 1 may be provided within a space formed by coupling the lower body 100a and the upper body 100b to each other (see FIG. 10).

In certain embodiments of the present disclosure, the body 100 may have a shape in which the width (or diameter) of the body 100 in the horizontal direction (e.g., a direction along the floor and parallel to the X-axis direction and the Y-axis direction shown in the drawings) is greater than the height of the body 100 in the vertical direction (e.g., a direction orthogonal to the floor and parallel to the Z-axis direction in the drawings). The body 100 may provide a structure favorable having a stable structure and avoiding obstacles during movement when the robot cleaner is traveling. When viewed from above or below, the body 100 may have various shapes, such as a circle, an oval, or a rectangle.

The first rotating plate 10 may be formed as a flat plate or a flat frame having a predetermined area. The first rotating plate 10 is generally laid horizontally. As such, the first rotating plate 10 may have a shape in which a width (or diameter) in the horizontal direction is significantly greater than a height in the vertical direction. The first rotating plate 10 coupled to the body 100 may be parallel to the floor surface B, or may be inclined with respect to the floor surface B. The first rotating plate 10 may have a circular plate shape, and the bottom surface of the first rotating plate 10 may have a roughly circular shape. The first rotating plate 10 may generally have a rotationally symmetrical shape.

The first rotating plate 10 may include a first central plate 11, a first outer plate 12, and first spokes 13. The first central plate 11 may form a center of the first rotating plate 10 and may be rotatably coupled to the body 100. The first central plate 11 may be coupled to the lower portion of the body 100 such that the upper surface of the first central plate 11 is directed towards the bottom surface of the body 100.

A rotation axis 15 of the first rotating plate 10 may be formed along a line passing through the center of the first central plate 11. Further, the rotation axis 15 of the first rotating plate 10 may be formed in a direction which is orthogonal to the floor surface B, or have a predetermined incline with respect to the direction orthogonal to the floor surface B. The first outer plate 12 may be spaced apart from the first central plate 11 so as to surround the first central plate 11.

The first spokes 13 may be formed in the circumferential direction of the first central plate 11 so as to connect the first central plate 11 to the first outer plate 12. The first spokes 13 may be arranged at substantially equal intervals, and a plurality of holes 14 which pass through the first central plate 11 vertically may be provided between adjacent first spokes 13, such that a liquid (for example, water or a cleaning fluid) may be discharged from a water supply tube 240 (to be described below) and transferred to the first mop 30 through these holes 14.

In the robot cleaner 1 according to certain embodiments of the present disclosure, the bottom surface of the first rotating plate 10 coupled to the body 100 may have a predetermined incline with respect to the floor surface B, and in this case, the rotation axis 15 of the first rotation plate 10 may have a predetermined incline with respect to the direction perpendicular to the floor surface B. In the robot cleaner 1 according to certain embodiments of the present disclosure, an angle 81 between the bottom surface of the first rotating plate 10 and the floor surface B may correspond to an angle 82 between the rotation axis 15 of the first rotating plate 10 and the vertical direction perpendicular to the floor surface B. Accordingly, when the first rotating plate 10 is rotated relative to the body 100, the bottom surface of the first rotating plate 10 may maintain a same angle relative to the floor surface B.

Similar to the first rotating plate 10, the second rotating plate 20 may be formed as a flat plate or a flat frame having a predetermined area. The second rotating plate 20 may be shaped to be generally laid horizontally. As such, the second rotating plate 20 may have a shape in which a width (or diameter) in the horizontal direction is significantly greater than a height in the vertical direction. The second rotating plate 20 coupled to the body 100 may be parallel to the floor surface B, or may be inclined with respect to the floor surface B. The second rotating plate 20 may have a circular plate shape, and the bottom surface of the second rotating plate 20 may have a roughly circular shape. The second rotating plate 20 may generally have a rotationally symmetrical shape.

The second rotating plate 20 may include a second central plate 21, a second outer plate 22, and second spokes 23. The second central plate 21 may form the center of the second rotating plate 20 and may be rotatably coupled to the body 100. The second central plate 21 may be coupled to the lower portion of the body 100 such that the upper surface of the second central plate 21 is directed towards the bottom surface of the body 100.

A rotation axis 25 of the second rotating plate 20 may be formed along a line passing through the center of the second central plate 21. Further, the rotation axis 25 of the second rotating plate 20 may be formed in a direction which is orthogonal to the floor surface B, or have a predetermined incline with respect to the direction orthogonal to the floor surface B.

The second outer plate 22 may be spaced apart from the second central plate 21 so as to surround the second central plate 21. The second spokes 23 may be repeatedly formed in the circumferential direction of the second central plate 21 so as to connect the second central plate 21 to the second outer plate 22. The second spokes 23 may be arranged at substantially equal intervals, a plurality of holes 24 which pass through the second central plate 21 vertically may be provided between adjacent second spokes 23 such that a liquid (for example, water or cleaning fluid) discharged from the water supply tube 240 (to be described below) may be transferred to the second mop 40 through these holes 24.

In the robot cleaner 1 according to an embodiment of the present disclosure, the bottom surface of the second rotating plate 20 coupled to the body 100 may have a predetermined incline with respect to the floor surface B, and in this case, the rotation axis 25 of the second rotation plate 20 may have a predetermined incline with respect to the direction perpendicular to the floor surface B. In the robot cleaner 1 according to an embodiment of the present disclosure, an angle 83 between the bottom surface of the second rotating plate 20 and the floor surface B may correspond to an angle 84 between the rotation axis 25 of the second rotating plate 20 and the direction perpendicular to the floor surface B. Accordingly, when the second rotating plate 20 is rotated relative to the body 100, the bottom surface of the second rotating plate 20 may maintain a same angle relative to the floor surface B.

In the robot cleaner 1 according to an embodiment of the present disclosure, the second rotating plate 20 may have the same structure as that of the first rotating plate 10, or may have a structure symmetrical to that of the first rotating plate 10. If the first rotating plate 10 is located on the left side of the robot cleaner 1, the second rotating plate 20 may be located on the right side of the robot cleaner 1, and in this case, the first rotating plate 10 and the second rotating plate 20 may be bilaterally symmetrical to each other.

The first mop 30 is configured such that the bottom surface of the first mop 30 positioned adjacent to the floor may have a predetermined area, and the first mop 30 may have a flat shape. The first mop 30 may have a shape in which the width (or diameter) of the first mop 30 in the horizontal direction is significantly greater than the height of the first mop 30 in the vertical direction. When the first mop 30 is coupled to the body 100, the bottom surface of the first mop 30 may be substantially parallel to the floor surface B, or may be inclined with respect to the floor surface B. The bottom surface of the first mop 30 may have a roughly circular shape. The first mop 30 may generally have a rotationally symmetrical shape.

The first mop 30 may be formed of various materials that can clean the floor while being in contact with the floor. For this purpose, the bottom surface of the first mop 30 may be formed of fabric, such as a woven, knitted fabric, or non-woven fabric, and/or a brush having a predetermined area, etc.

In the robot cleaner 1 according to an embodiment of the present disclosure, the first mop 30 may be detachably attached to the bottom surface of the first rotating plate 10 and may be rotated together with the first rotating plate 10. The first mop 30 may be tightly coupled to the bottom surface of the first outer plate 12 and, more particularly, may be tightly coupled to the bottom surfaces of the first central plate 11 and the first outer plate 12.

The first mop 30 may be detachably attached to the first rotating plate 10 using various devices and methods. In one embodiment, at least a portion of the first mop 30 may be coupled to the first rotating plate 10 using, for example, an engagement method or a fitting method. In one example, a separate device, such as a clamp, which couples the first mop 30 to the first rotating plate 10, may be provided. In yet another example, a pair of fasteners which are separably coupled to each other, (for example, a pair of magnets which are attracted to each other, a pair of Velcro strips which are coupled to each other, or a pair of buttons (a female button and a male button) which are shaped to be coupled to each other) may be used such that one of the fasteners is fixed to the first mop 30 and the other of the fasteners is fixed to the first rotating plate 10. When the first mop 30 is coupled to the first rotating plate 10, the first mop 30 and the first rotating plate 10 may be coupled to overlap each other, and the first mop 30 may be coupled to the first rotating plate 10 such that the center of the first mop 30 substantially coincides with the center of the first rotating plate 10.

The second mop 40 may be configured such that the bottom surface of the second mop 40 adjacent to the floor has a predetermined area, and the second mop 40 has a flat shape. The second mop 40 may have a shape in which the width (or diameter) of the second mop 40 in the horizontal direction is significantly greater than the height of the second mop 40 in the vertical direction. When the second mop 40 is coupled to the body 100, the bottom surface of the second mop 40 may extend be substantially parallel to the floor surface B or may be inclined with respect to the floor surface B. The bottom surface of the second mop 40 may have a roughly circular shape. The second mop 40 may generally have a rotationally symmetrical shape.

The second mop 40 may be formed of various materials which may contact the floor and thus mop the floor. For this purpose, the bottom surface of the second mop 40 may be formed of fabric, such as woven, knitted, or non-woven fabric, and/or a brush having a predetermined area.

In the robot cleaner 1 according to an embodiment of the present disclosure, the second mop 40 may be detachably attached to the bottom surface of the second rotating plate 20 and may be rotated together with the second rotating plate 20. The second mop 40 may be tightly coupled to the bottom surface of the second outer plate 22 and, more particularly, may be tightly coupled to the bottom surfaces of the second central plate 21 and the second outer plate 22.

The second mop 40 may be detachably attached to the second rotating plate 20 using various devices and/or methods. In one example, at least a portion of the second mop 40 may be coupled to the second rotating plate 20 using, for example, an engagement method or a fitting method. In another example, a separate device, such as a clamp, which couples the second mop 40 to the second rotating plate 20 may be provided. In yet another example, a pair of fasteners which are separably coupled to each other, (for example, a pair of magnets which are attracted to each other, a pair of Velcro strips which are coupled to each other, or a pair of buttons (a female button and a male button) which are coupled to each other) may be used such that one of the fasteners is fixed to the second mop 40 and the other one of the fasteners is fixed to the second rotating plate 20. When the second mop 40 is coupled to the second rotating plate 20, the second mop 40 and the second rotating plate 20 may be coupled to overlap each other, and the second mop 40 may be coupled to the second rotating plate 20 such that the center of the second mop 40 coincides with the center of the second rotating plate 20.

The robot cleaner 1 according to an embodiment of the present disclosure may be configured to move substantially rectilinearly along the floor surface B. For example, the robot cleaner 1 may move rectilinearly forwards (in the X-axis direction) during cleaning, or move rectilinearly backwards when necessary to avoid an obstacle or a cliff.

In the robot cleaner 1 according to an embodiment of the present disclosure, the first rotating plate 10 and the second rotating plate 20 may respectively be inclined with respect to the floor surface B such that the sides of the first rotating plate 10 and the second rotating plate 20 that are closer to each other (e.g., sides adjacent to a central axis extend front to back of the main body 100) may be spaced further apart from the floor surface B than the sides of the first rotating plate 10 and the second rotating plate 20 that are farther from each other. That is, the first rotating plate 10 and the second rotating plate 20 may be configured such that the sides of the first rotating plate 10 and the second rotating plate 20 that are farther from the center of the robot cleaner 1 are located closer to the floor than the sides of the first rotating plate 10 and the second rotating plate 20 that are closer to the center of the robot cleaner 1 (see FIGS. 3 and 4).

Here, the rotation axis 15 of the first rotating plate 10 may be perpendicular to the bottom surface of the first rotating plate 10, and the rotation axis 25 of the second rotating plate 25 may be perpendicular to the bottom surface of the second rotating plate 20. When the first mop 30 is coupled to the first rotating plate 10 and the second mop 40 is coupled to the second rotating plate 20, the sides of the first mop 30 and the second mop 40 that are farther from each other may be in greater contact with the floor.

When the first rotating plate 10 is rotated, frictional force is generated between the bottom surface of the first mop 30 and the floor surface B. In this case, since the generation point and direction of the frictional force deviate from the rotation axis 15 of the first rotating plate 10, the first rotating plate 10 may move relative to the floor surface B, and the robot cleaner 1 may also move along the floor surface B.

Further, when the second rotating plate 20 is rotated, frictional force is generated between the bottom surface of the second mop 40 and the floor surface B. In this case, since the generation point and direction of the frictional force may deviate from the rotation axis 25 of the second rotating plate 20, the second rotating plate 20 may move relative to the floor surface B, and the robot cleaner 1 may also move along the floor surface B.

When the first rotating plate 10 and the second rotating plate 20 are rotated at the same speed in opposite directions, the robot cleaner 1 may move in a rectilinear direction, i.e., move forwards or backwards. For example, when viewed from above, if the first rotating plate 10 is rotated in the counterclockwise direction and the second rotating plate 20 is rotated in the clockwise direction, the robot cleaner 1 may move forwards.

When only one of the first rotating plate 10 and the second rotating plate 20 is rotated, the robot cleaner 1 may change the direction, and may thus turn. When the rotational speed of the first rotating plate 10 and the rotational speed of the second rotating plate 20 are different, or when the first rotating plate 10 and the second rotating plate 20 are rotated in the same direction, the robot cleaner 1 may move while changing direction, and thus move in a curvilinear direction.

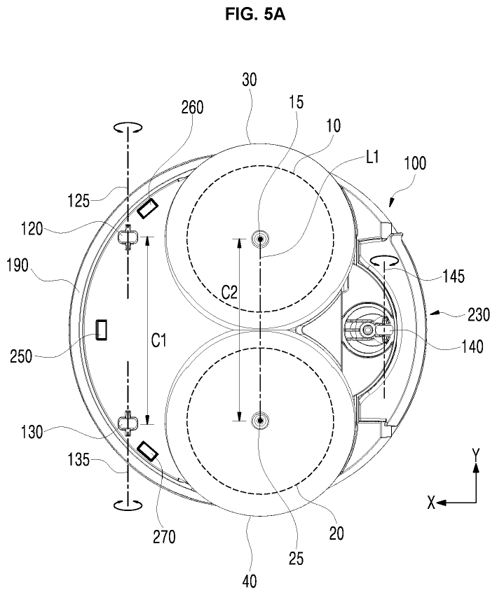

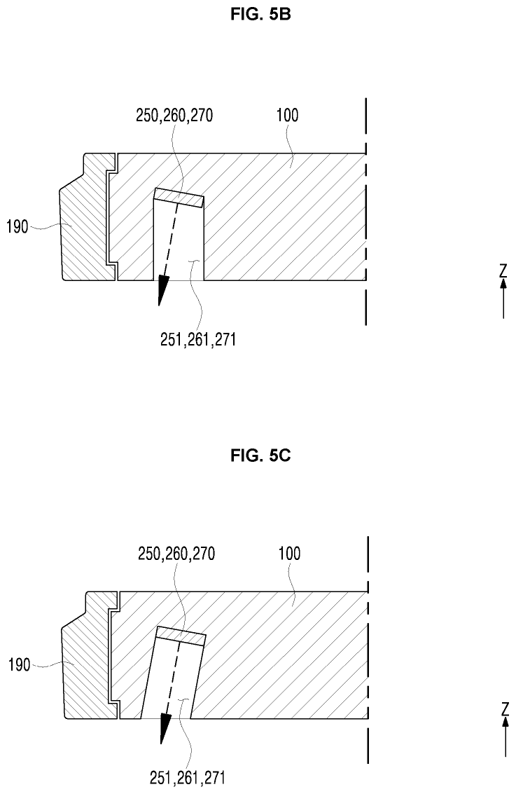

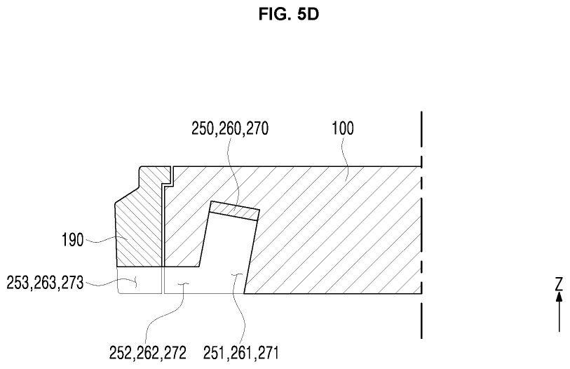

FIG. 5A is a bottom diagram illustrating a robot cleaner 1 according to an embodiment of the present disclosure, and FIG. 5B is a cross-sectional diagram schematically illustrating a portion of the robot cleaner 1 according to an embodiment of the present disclosure in which a first lower sensor (also referred to as a first sensor or first cliff sensor) 250, a second lower sensor (also referred to as a second sensor or a second cliff sensor) 260, or a third lower sensor (also referred to as a second sensor or a second cliff sensor) 270 is coupled to a body. FIGS. 5C and 5D are cross-sectional diagrams, each of which schematically illustrates a portion of a robot cleaner according to an embodiment of the present disclosure in which a first lower sensor 250, a second lower sensor 260, or a third lower sensor 270 is coupled to a body. The robot cleaner 1 according to an embodiment of the present disclosure may include a first support wheel (also referred to as a first wheel or a first caster) 120, a second support wheel (also referred to as a second wheel or a second caster) 130, and the first lower sensor 250.

The first support wheel 120 and the second support wheel 130, together with a first mop 30 and a second mop 40, may be configured to contact a floor. The first support wheel 120 and the second support wheel 130 may be spaced apart from each other, and may be formed as conventional wheels. The first support wheel 120 and the second support wheel 130 may contact the floor and move while rolling thereon, and thereby, the robot cleaner 1 may move along the floor surface B.

The first support wheel 120 may be coupled to the bottom surface of the body 100 at a point spaced apart from a first rotating plate 10 and a second rotating plate 20, and the second support wheel 130 may also be coupled to the bottom surface of the body 100 at a point spaced apart from the first rotating plate 10 and the second rotating plate 20. A virtual line connecting the center of the first rotating plate 10 (e.g., first rotational axis 15) and the center of the second rotating plate 20 (e.g., second rotational axis 25) in the horizontal direction (e.g., a direction parallel to the floor surface B) may be referred to as a connection line L1, and the second support wheel 13 may be located at the same side (e.g., a front side) of the connection line L1 as the first support wheel 12, while an auxiliary wheel 140 (to be described below) may located at the other side (e.g., a rear side) of the connection line L1. As used herein, a left-to-right direction may correspond to a horizontal direction associated with connection line L1, and a front-to-rear direction may correspond to a horizontal direction orthogonal to connection line L1.

The distance between the first support wheel 120 and the second support wheel 130 may be comparatively great in consideration of the overall size of the robot cleaner 1. In more detail, under the condition that the first support wheel 120 and the second support wheel 130 are placed on the floor surface B (under the condition that a rotation axis 125 of the first support wheel 120 and a rotation axis 135 of the second support wheel 130 are parallel to the floor surface B), the first support wheel 120 and the second support wheel 130 may be spaced apart from each other by a sufficient distance to make the robot cleaner 1 stand upright without falling sideways while supporting a portion of the load of the robot cleaner 1.

The first support wheel 120 may be located in front of the first rotating plate 10, and the second support wheel 130 may be located in front of the second rotating plate 20. In the robot cleaner 1 according to an embodiment of the present disclosure, a center of gravity 105 of the robot cleaner 1 may be located closer to the first mop 30 and the second mop 40 than to the first support wheel 120 and the second support wheel 130, and the load of the robot cleaner 1 may be more greatly supported by the first mop 30 and the second mop 40 than by the first support wheel 120 and the second support wheel 130.

The first lower sensor 250 is provided in the lower portion of the body 100 so as to sense a relative distance from the floor surface B. The first lower sensor 250 may be variously configured, as long as the first lower sensor 250 can sense a relative distance between the mounting point of the first lower sensor 250 and the floor surface B. When the relative distance between the first lower sensor 250 and the floor surface B sensed by the first lower sensor 250 (e.g., a distance from the floor surface B in the vertical direction or a distance from the floor surface B in an inclined direction) exceeds a predetermined value or deviates from a predetermined range, this sensing result may indicate a situation in which the floor surface B suddenly drops, and in this case, the first lower sensor 250 may sense a cliff.

The first lower sensor 250 may include an optical sensor including a light emitter which emits light and a light receiver on which reflected light is incident. The first lower sensor 250 may include an infrared sensor. The first lower sensor 250 may be referred to as a cliff sensor.

The first lower sensor 250 may be located at the same side of the connection line L1 as the first support wheel 120 and the second support wheel 130 (e.g., toward a front of the body 100). The first lower sensor 250 is located in a region that extends between the first support wheel 120 and the second support wheel 130 and along the edge of the body 100. In the robot cleaner 1, if the first support wheel 120 is located at a relatively left region and the second support wheel 130 is located at a relatively right region, the first lower sensor may be located at a relatively central region and forward of the wheels 120, 130.

Further, the distance from the connection line L1 to the first lower sensor 150 (the distance from the connection line L1 in the vertical direction) may be greater than the distance from the connection line L1 to the first support wheel 120 or the second support wheel 130 (the distance from the connection line L1 in the vertical direction). That is, the first lower sensor 250 may be formed further forward than the support wheels 120 and 130.

When the first lower sensor 250 is provided in the lower surface of the body 100, in order to prevent sensing of a cliff by the first lower sensor 250 from being interfered with by the first mop 30 and the second mop 40 and to rapidly sense a cliff located in front of the robot cleaner 1, the first lower sensor 250 may be provided at a point spaced sufficiently far apart from the first rotating plate 10 and the second rotating plate 20 (and is also spaced sufficiently far apart from the first mop 30 and the second mop 40). Thus, the first lower sensor 250 may be provided adjacent to the edge of the body 100 such that the first lower sensor 250 can detect a cliff while the first and second rotating plates 10 and 20 arrive at the cliff.

The robot cleaner 1 according to an embodiment of the present disclosure may be configured such that the operation of the robot cleaner 1 is controlled depending on a distance sensed by the first lower sensor 250. In more detail, the rotation of one or more of the first rotating plate 10 or the second rotating plate 20 may be controlled depending on the distance sensed by the first lower sensor 250. For example, when the distance sensed by the first lower sensor 250 exceeds a predetermined value or deviates from a predetermined range (e.g., distance from the lower sensor 250 to the floor is greater than a threshold value or cannot be determined), rotation of the first rotating plate 10 and the second rotating plate 20 may be stopped such that an operation of the robot cleaner 1 may be stopped, or the rotating direction of the first rotating plate 10 and/or the second rotating plate 20 may be changed such that the moving direction of the robot cleaner 1 may be changed to move away from a detected cliff.

In an embodiment of the present disclosure, the sensing direction of the first lower sensor 250 may be inclined downwards and towards the edge of the body 100. For example, when the first lower sensor 250 is an optical sensor, the direction of light emitted by the first lower sensor 250 may not be perpendicular to the floor surface B, but be inclined forwards toward an edge of the body 100 (see FIG. 5B). Accordingly, the first lower sensor 250 may sense a cliff which is located further forward than the first lower sensor 250 and comparatively in front of the body 10, and movement of the robot cleaner may be controlled to prevent the robot cleaner 1 from entering the cliff.

A first sensor hole (or first sensor channel) 251, through which the first lower sensor 250 is exposed, may be formed in the lower surface of the body 100. That is, the first lower sensor 250 may sense a cliff through the first sensor hole 251. The first sensor hole 251 may be formed to be inclined downwards towards the edge of the body 100, and thereby, the first lower sensor 250 may more effectively sense a cliff which is located further forward than the first lower sensor 250 and prevent the robot cleaner 1 from entering the cliff (see FIG. 5C).

Further, a first sensor recess 252 may be formed in the bottom surface of the body 100, and a first bumper recess 253 may be formed in the bottom surface of a bumper 190 to be described below. One side of the first sensor recess 252 may be connected to the first sensor hole 251, and the other side of the first sensor recess 252 may extend towards the edge of the body 100 and be connected to the first bumper recess 253. That is, the first sensor hole 251, the first sensor recess 252, and the first bumper recess 253 may be continuously arranged in the radial direction of the robot cleaner 1 and communicate with one another (see FIG. 5D). The first lower sensor 250 may effectively sense a cliff which is located further forward than the first lower sensor 250, through the first sensor hole 251, the first sensor recess 252, and the first bumper recess 253.

The robot cleaner 1 according to an embodiment of the present disclosure may include the bumper 190 which senses an obstacle, as described below. Here, in order to sense the obstacle (for example, a carpet) laid on the floor surface B, the lowermost portion of the bumper 190 may be located comparatively close to the floor surface B. As such, even when the lowermost portion of the bumper 190 is located at a comparatively low position, providing the first sensor recess 252 and the first bumper recess 253 may allow the first lower sensor 250 to effectively sense a cliff which is located further forward than the first lower sensor 250.

In another example, the robot cleaner 1 may include a single support wheel 120, such as a single wheel that extends in a left-to-right direction to extend through a centerline of the body 100. For example, a length of the single wheel 120 may correspond to a length of connection line C1 between first and second rotational axes 15 and 25. The first lower sensor 250 may be positioned in front of the support wheel 120 (e.g., first lower sensor 250 may be positioned further from the connection line C1 than the support wheel 120). The second and third lower sensors 260 and 270 may be positioned behind and further from the centerline than the ends of the wheel 120.

Although described here as passive support wheels, it should be appreciated that wheels 120, 130 may be driven to rotate by motor included in the body 120. For example, the wheels 120, 130 may be rotated to move the main body 100 in connection with the mops 30, 40 or when the mops 30, 40 are not operating. In another example, the wheels 120, 130 may be rotated to change a moving direction of the main body 100. In another example, a rotational axis of the wheels 120, 130 may be adjusted, such as turn left or right to change a moving direction of the main body 100.

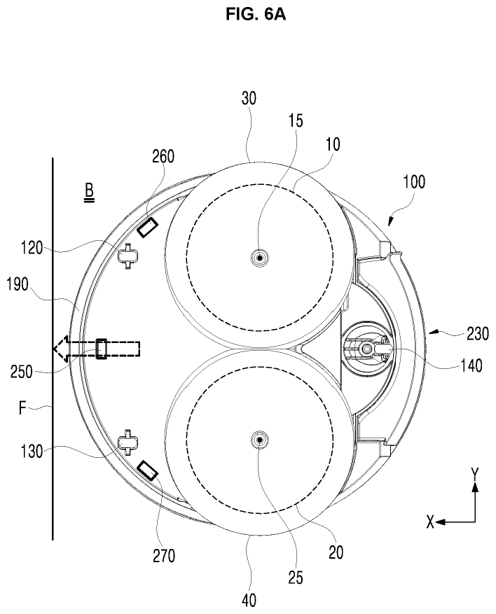

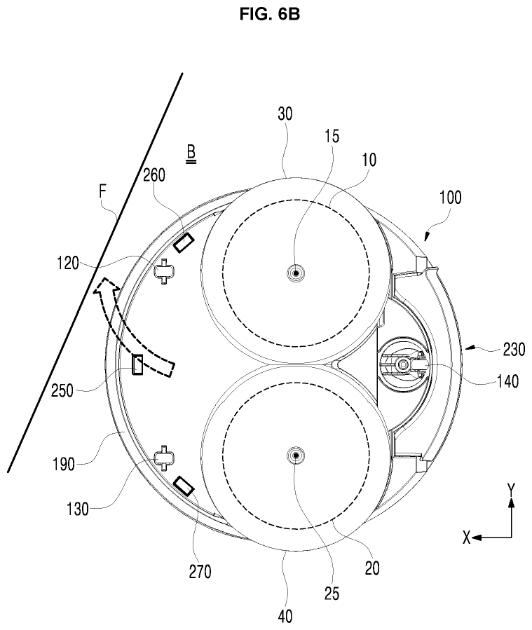

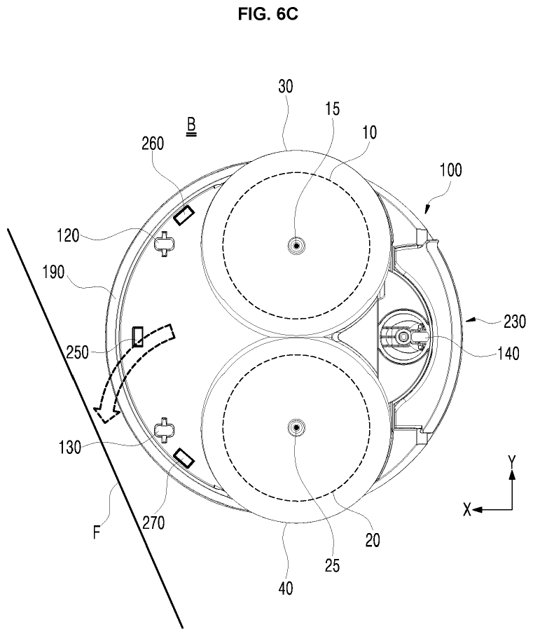

FIGS. 6A to 6C are diagrams illustrating sensing of a cliff F by the first lower sensor 250 during rectilinear movement or turning of the robot cleaner 1 shown in FIG. 5A. When the robot cleaner 1 according to an embodiment of the present disclosure moves, the cliff F may be located at a random point based on the robot cleaner 1, and the robot cleaner 1 may move rectilinearly, change direction, or turn. Even in this case, the robot cleaner 1 according to an embodiment of the present disclosure is configured to effectively avoid the cliff F or to maintain stable operation.

The robot cleaner 1 according to an embodiment of the present disclosure may move (rectilinearly) forwards during cleaning, and in this case, the first mop 30, the second mop 40, the first support wheel 120 and the second support wheel 130 may contact the floor and support the load of the robot cleaner 1. When the robot cleaner 1 moves forwards along the floor surface B, the first lower sensor 250 may sense whether the cliff F is present, and the sensing of the cliff F by the first lower sensor 250 may be performed before the first support wheel 120 or the second support wheel 130 supporting the load of the robot cleaner 1 enters the cliff F (see FIG. 6A).

The robot cleaner 1 according to an embodiment of the present disclosure may change direction leftwards or rightwards and move in a curvilinear direction during cleaning, and in this case, the first mop 30, the second mop 40, the first support wheel 120, and the second support wheel 130 contact the floor and support the load of the robot cleaner 1. As shown in FIG. 6B, when the robot cleaner 1 moves while changing direction leftwards, sensing of the cliff F by the first lower sensor 250 may be performed before the first support wheel 120 or the second support wheel 130 enters the cliff F, and specifically, sensing of the cliff F by the first lower sensor 250 may be performed at least before the second support wheel 130 enters the cliff F. When the first lower sensor 250 senses the cliff F, the load of the robot cleaner 1 is supported by the first mop 30, the second mop 40, the first support wheel 120, and the second support wheel 130, and specifically, is supported by at least the first mop 30, the second mop 40, and the first support wheel 120.

As shown in FIG. 6C, when the robot cleaner 1 moves while being rotated rightwards, sensing of the cliff F by the first lower sensor 250 may be performed before the first support wheel 120 or the second support wheel 130 enters the cliff F, and specifically, sensing of the cliff F by the first lower sensor 250 may be performed at least before the first support wheel 120 enters the cliff F. When the first lower sensor 250 senses the cliff F, the first mop 30, the second mop 40, the first support wheel 120, and the second support wheel 130 support the load of the robot cleaner 1, and specifically, at least the first mop 30, the second mop 40, and the first support wheel 120 support the load of the robot cleaner 1.

As described above, in the robot cleaner 1 according to an embodiment of the present disclosure, when the robot cleaner 1 moves rectilinearly or changes direction, the first lower sensor 250 may sense the cliff F before the first support wheel 120 and the second support wheel 130 enter the cliff F and are, thus, being capable of preventing the robot cleaner 1 from falling off the cliff F and losing its balance.

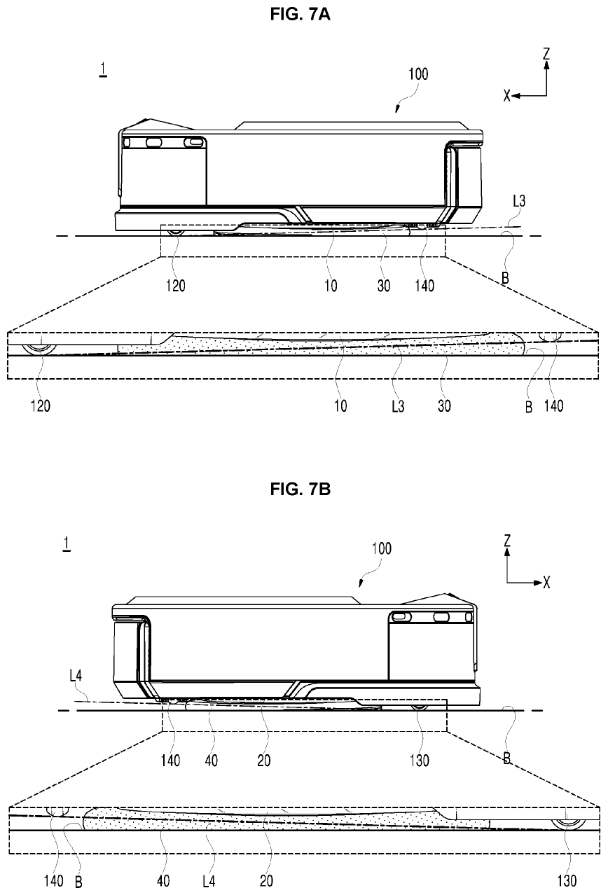

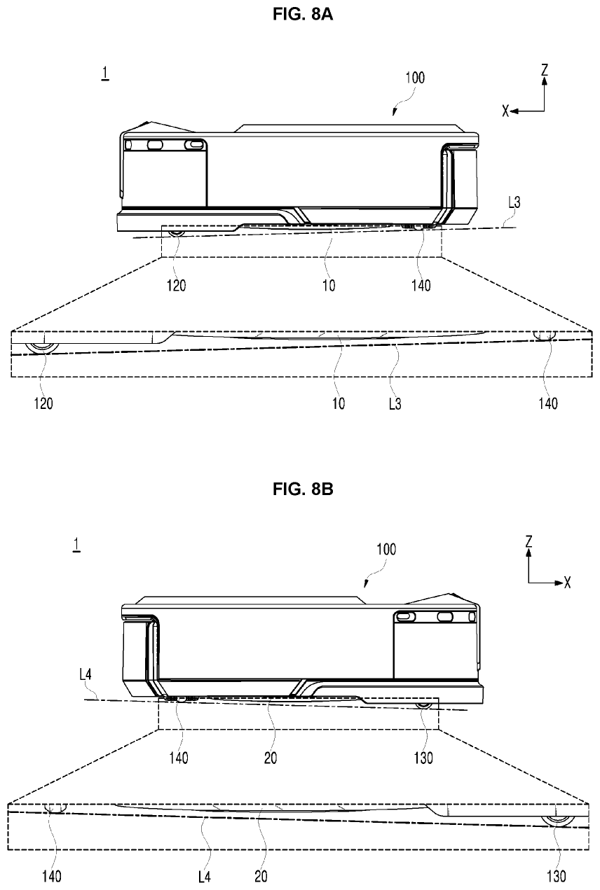

FIGS. 7A and 7B are side diagrams illustrating the robot cleaner 1 shown in FIG. 5A, and FIGS. 8A and 8B are side diagrams illustrating the robot cleaner 1 shown in FIG. 5A from which some elements are removed. The robot cleaner 1 according to an embodiment of the present disclosure may include the auxiliary wheel 140 in addition to the first support wheel 120 and the second support wheel 130.

The auxiliary wheel 140 may be coupled to the lower portion of the body 100 so as to be spaced apart from the first rotating plate 10 and the second rotating plate 20. The auxiliary wheel 140 is located at the other side of the connection line L1 opposite to the side of the connection line L1 at which the first support wheel 120 and the second support wheel 130 are located.

In an embodiment of the present disclosure, the auxiliary wheel (also referred to as a rear wheel or as a third wheel or caster) 140 may be formed as a conventional wheel, and a rotation axis 145 of the auxiliary wheel 140 may be parallel to the floor surface B. The auxiliary wheel 140 may contact the floor and move while rolling thereon, and thereby, the robot cleaner 1 may move along the floor surface B. However, the auxiliary wheel 140 according to an embodiment of the present disclosure may be configured to not contact the floor when the first mop 30 and the second mop 40 contact the floor.

The first support wheel 120 and the second support wheel 130 are located in front of the first rotating plate 10 and the second rotating plate 20, and the auxiliary wheel 140 is located behind the first rotating plate 10 and the second rotating plate 20. In the robot cleaner 1 according to an embodiment of the present disclosure, the first rotating plate 10 and the second rotating plate 20 may be symmetrical (bilaterally symmetrical) to each other, and the first support wheel 120 and the second support wheel 130 may be symmetrical (bilaterally symmetrical) to each other.

In the robot cleaner 1 according to an embodiment of the present disclosure, the height of the lowermost portion of the first rotating plate 10 may be higher than a virtual first reference line L3 connecting the lowermost portion of the first support wheel 120 and the lowermost portion of the auxiliary wheel 140, and the height of the lowermost portion of the first mop 30 may be lower than the first reference line L3 (see FIG. 8A). Further, the height of the lowermost portion of the second rotating plate 20 may be higher than a virtual second reference line L4 connecting the lowermost portion of the second support wheel 130 and the lowermost portion of the auxiliary wheel 140, and the height of the lowermost portion of the second mop 40 may be lower than the second reference line L4 (see FIG. 8B).

That is, in the robot cleaner 1 according to an embodiment of the present disclosure, under the condition that the first mop 30 is coupled to the first rotating plate 10 and the second mop 40 is coupled to the second rotting plate 20, the first support wheel 120, the second support wheel 130, and the auxiliary wheel 140 do not interfere with contact of the first mop 30 and the second mop 40 with the floor. Therefore, the first mop 30 and the second mop 40 come into contact with the floor, and mopping and cleaning may be performed by rotation of the first mop 30 and the second mop 40. Here, all of the first support wheel 120, the second support wheel 130, and the auxiliary wheel 140 may be spaced apart from the floor, or the auxiliary wheel 140 may be spaced apart from the floor and the first support wheel 120 and the second support wheel 130 may be in contact with the floor.

In an embodiment of the present disclosure, under the condition that the robot cleaner 1 is placed such that the first mop 30 and the second mop 40 are in contact with the floor, the height from the floor surface B to the lowermost portion of the first support wheel 120 and the height from the floor surface B to the lowermost portion of the second support wheel 130 may be lower than the height from the floor surface B to the lowermost portion of the auxiliary wheel 140.

Further, under the condition that the first mop 30 and the second mop 40 are separated from the first rotating plate 10 and the second rotating plate 20, the first support wheel 120, the second support wheel 130, and the auxiliary wheel 140 come into contact the floor, and the first rotating plate 10 and the second rotating plate 20 are spaced apart from the floor (see FIGS. 8A and 8B). In this state, even if the robot cleaner 1 is unintentionally operated (that is, even if the first rotating plate 10 and the second rotating plate 20 are rotated), friction caused by contact of the first rotating plate 10 and the second rotating plate 20 with the floor may be prevented, and thus, damage to the first rotating plate 10 and the second rotating plate 20 and damage to the floor may be prevented. Further, in this state, even if the robot cleaner 1 unintendedly moves along the floor, the first support wheel 120, the second support wheel 130, and the auxiliary wheel 140 may roll and move along the floor, and thus, scratching on the floor may be prevented and damage to the robot cleaner 1 or to the floor may be effectively prevented.

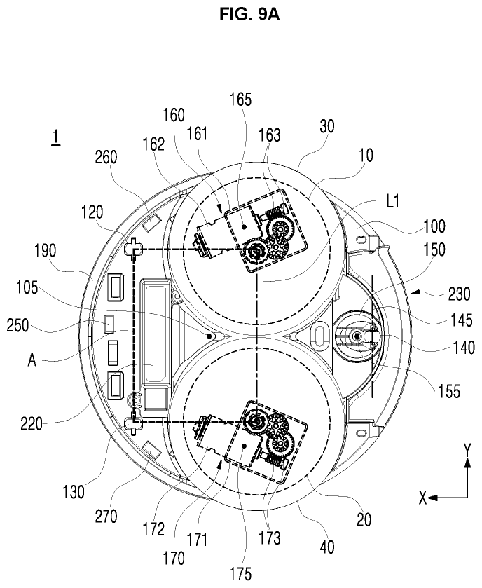

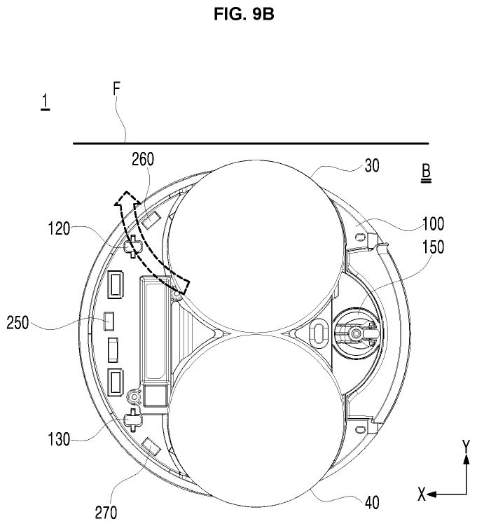

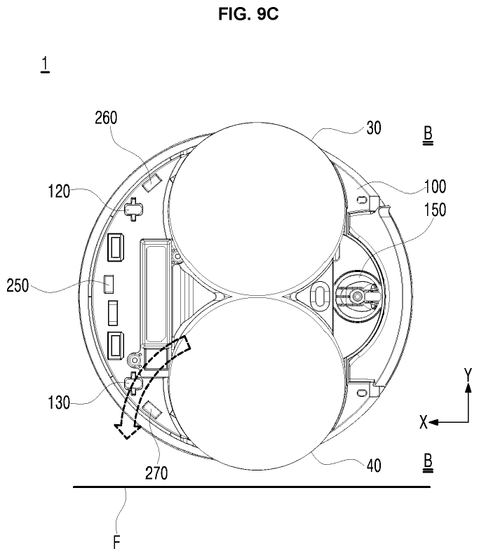

FIG. 9A is a bottom diagram illustrating a robot cleaner 1 according to an embodiment of the present disclosure, and FIGS. 9B and 9C are diagrams illustrating sensing of a cliff by a second lower sensor 260 or a third lower sensor 270 in the robot cleaner 1 shown in FIG. 9A. FIG. 10 is an exploded perspective diagram illustrating the robot cleaner 1 shown in FIG. 9A. The robot cleaner 1 according to an embodiment of the present disclosure includes a first actuator (or first motor) 160, a second actuator (or second motor) 170, a battery 220, a water bottle (or liquid container) 230, and a water supply tube (or liquid supply tube) 240. The first actuator 160 is coupled to a body 100, and rotates a first rotating plate 10. The first actuator 160 may include a first case 161, a first motor 162, and one or more first gears 163. The first case 161 supports elements of the first actuator 160, and is fixedly coupled to the body 100. The first motor 162 may be formed as an electric motor.

A plurality of first gears 163 are configured to be engaged with each other so as to be rotated, and serve to connect the first motor 162 and the first rotating plate 10 and to transmit rotational power of the first motor 162 to the first rotating plate 10. As a result, the first rotating plate 10 rotates upon rotation of the rotation axis of the first motor 162.

The second actuator 170 is coupled to the body 100, and rotates a second rotating plate 20. The second actuator 170 may include a second case 171, a second motor 172, and one or more second gears 173. The second case 171 supports elements of the second actuator 170, and is fixedly coupled to the body 100. The second motor 172 may be formed as an electric motor.

A plurality of second gears 173 are configured to be engaged with each other so as to be rotated, and serve to connect the second motor 172 and the second rotating plate 20 and to transmit rotational power of the second motor 172 to the second rotating plate 20. As a result, the second rotating plate 20 rotates upon rotation of the rotation axis of the second motor 172.

In the robot cleaner 1 according to an embodiment of the present disclosure, the first rotating plate 10 and the first mop 30 may be rotated by the operation of the first actuator 160, and the second rotating plate 20 and the second mop 40 may be rotated by the operation of the second actuator 170.

In an embodiment of the present disclosure, a center of gravity 165 of the first actuator 160 may be located inside a vertical area formed by the first rotating plate 10. That is, by disposing the first actuator 160 just above the first rotating plate 10, loss of power transmitted from the first actuator 160 to the first rotating plate 10 may be minimized, and by applying a load of the first actuator 160, which functions as a weight, to the first rotating plate 10, the first mop 30 may mop the floor while being sufficiently strongly rubbed against the floor.

Further, in an embodiment of the present disclosure, a center of gravity 175 of the second actuator 170 may be located inside a vertical area formed by the second rotating plate 20. That is, by disposing the second actuator 170 directly on the second rotating plate 20, loss of power transmitted from the second actuator 170 to the second rotating plate 20 may be minimized, and by applying a load of the second actuator 170, which functions as a weight, to the second rotating plate 20, the second mop 40 may mop the floor while sufficiently rubbing the floor. The second actuator 170 may be symmetrical to the first actuator 160 along a center axis extending in front-to-rear direction such that the cleaning robot 1 may be substantially bilaterally symmetric.

The battery 220 is coupled to the body 100 so as to supply power to the elements forming the robot cleaner 1. The battery 220 may supply power to the first actuator 160 and the second actuator 170, and particularly, supply power to the first motor 162 and the second motor 172. In an embodiment of the present disclosure, the battery 220 may be charged by an external power supply, and for this purpose, a charging terminal for charging the battery 220 may be provided on one side of the body 100 or the battery 220 itself.

In the robot cleaner 1 according to an embodiment of the present disclosure, the battery 220 may be located inside a rectangular vertical area A formed using the center of the first rotating plate 10, the center of the second rotating plate 20, the center of the first support wheel 120, and the center of the second support wheel 130 as the respective vertices. That is, the battery 220 may be located in front of the connection line L1. In the robot cleaner 1 according to an embodiment of the present disclosure, the battery 220 may be coupled to the body 100 such that the length direction of the battery 220 is parallel to the connection line L1.

The water bottle 230 is formed as a container having an inner space so as to store a liquid, such as water, therein. The water bottle 230 may be fixedly coupled to the body 100, or be detachably coupled to the body 100 such that the bottle 230 may be removed by a user and filled. In an embodiment of the preset disclosure, the water bottle 230 may be located behind the connection line L1, and may be located above the auxiliary wheel 140.

The water supply tube 240 may be formed as a tube or a pipe, and may be connected at an input end to the water bottle 230 so that the liquid within the water bottle 230 may flow through the input end and into the inside of the water supply tube 240. Output ends of the water supply tube 240 that are opposite to the input end connected to the water bottle 230 may be located, respectively, above the first rotating plate 10 and the second rotating plate 20, and thereby, the liquid within the water bottle 230 may be supplied via the water supply tube 240 to the first mop 30 and the second mop 40.

In the robot cleaner 1 according to an embodiment of the present disclosure, the water supply tube 240 may be formed such that one input tube is branched off into two output tubes, and in this case, one end of the branched tube may be located above the first rotating plate 10 and the other end of the branched tube may be located above the second rotating plate 20. In the robot cleaner 1 according to an embodiment of the present disclosure, in order to move the liquid through the water supply tube 240, a separate pump may be provided. In another example, a valve may be provided in the water supply tube 240, the water bottle 230, or at an connection between the water supply tube 240 and the water bottle, and the valve may be selectively opened or closed to regulate a flow of liquid into the water supply tube 240. For example, at least a portion of the water supply tube 240 may be positioned lower than a lower surface of the water battle 230 such that liquid is drawn into the water supply tube 240 by gravity, air pressure, a syphon effect, a capillary effect, etc.

The center of gravity 105 of the robot cleaner 1 may be located inside the rectangular vertical area A formed using the center of the first rotating plate 10, the center of the second rotating plate 20, the center of the first support wheel 120, and the center of the second support wheel 130 as the respective vertices. Accordingly, the robot cleaner 1 may supported by the first mop 30, the second mop 40, the first support wheel 120, and the second support wheel 130.

In the robot cleaner 1 according to an embodiment of the present disclosure, each of the first actuator 160, the second actuator 170, the battery 220, and the water bottle 230 may function as a weight. The first actuator 160 and the second actuator 170 may be located on the connection line L1 or be located adjacent to the connection line L1, the battery 220 may be located in front of the connection line L1, and the water bottle 230 may be located behind the connection line L1, and thereby, the center of gravity 105 of the robot cleaner 1 may be located at the central portion of the robot cleaner 1. Accordingly, the first mop 30 and the second mop 40 may be in stable contact with the floor and supported by the wheels 120, 130 and the mops 30, 40. Further, since the first actuator 160, the second actuator 170, the battery 220 and the water bottle 230 are respectively located in different regions on a plane, the body 100 of the robot cleaner 1 may have a comparatively flat shape due to the stable weight distribution thereof, and the robot cleaner 1 may easily enter a space under a shelf or a table.

Further, in the robot cleaner 1 according to an embodiment of the present disclosure, when the robot cleaner 1 is initially operated when the water bottle 230 is significantly filled with liquid, the weight may be distributed such that cleaning is performed while only the first mop 30 and the second mop 40 contact the floor (e.g., the center of gravity is positioned along line L1). Here, even when the liquid in the water bottle 230 is used up and the center of gravity 105 of the robot cleaner 1 is shifted forwards, cleaning may be performed while the moving robot 1 continues to be stably supported by the first mop 30, the second mop 40, the first support wheel 120, and the second support wheel 130 contacting the floor. Further, in the robot cleaner 1 according to an embodiment of the present disclosure, cleaning may be performed while the first support wheel 120 and the second support wheel 130, together with the first mop 30 and the second mop 40, contact the floor, regardless of whether or not the liquid in the water bottle 230 is used up.

The robot cleaner 1 according to an embodiment of the present disclosure may include the second lower sensor 260 and the third lower sensor 270. The second lower sensor 260 and the third lower sensor 270 may be formed in the lower portion of the body 100 at the same side of the connection line L1 as the first support wheel 120 and the second support wheel 130, and may sense relative distances between the second lower sensor 260 and the third lower sensor 270 and the floor surface B.

When the second lower sensor 260 is provided in the lower surface of the body 100, in order to prevent sensing of a cliff F by the second lower sensor 260 from being interfered with by the first mop 30 and the second mop 40, the second lower sensor 260 is spaced apart from the first mop 30 and the second mop 40. Further, in order to rapidly sense a cliff F located at the left side or right side of the robot cleaner 1, the second lower sensor 260 may be provided at a point which is outwardly spaced from the first rotating plate 10 and the second rotating plate 20. The second lower sensor 260 may be provided adjacent to the edge of the body 100.

The second lower sensor 260 may be provided at one side of the first support wheel 120 opposite to the other side thereof at which the first lower sensor 250 is provided. Accordingly, sensing of a cliff F at one side of the first support wheel 120 may be performed by the second lower sensor 260 and sensing of the cliff F at the other side of the first support wheel 120 may be performed by the first lower sensor 250, and thus, the cliff F located around the first support wheel 120 may be effectively sensed.

When the third lower sensor 270 is provided in the lower surface of the body 100, in order to prevent sensing of a cliff F by the third lower sensor 270 from being interfered with by the first mop 30 and the second mop 40, the third lower sensor 270 is spaced apart from the first mop 30 and the second mop 40. Further, in order to rapidly sense a cliff F located at the left side or right side of the robot cleaner 1, the third lower sensor 270 may be provided at a point which is outwardly spaced from the first rotating plate 10 and the second rotating plate 20. The third lower sensor 270 may be provided adjacent to the edge of the body 100.

The third lower sensor 270 may be provided at one side of the second support wheel 130 opposite to the other side thereof at which the first lower sensor 250 is provided. Therefore, sensing of a cliff F at one side of the second support wheel 130 may be performed by the third lower sensor 270 and sensing of the cliff F at the other side of the second support wheel 130 may be performed by the first lower sensor 250, and thus, the cliff F located around the second support wheel 130 may be effectively sensed. Thus, in the robot cleaner 1 according to an embodiment of the present disclosure, the second lower sensor 260, the first support wheel 120, the first lower sensor 250, the second support wheel 130, and the third lower sensor 270 may be sequentially arranged along the edge of the body 100.

Each of the second lower sensor 260 and the third lower sensor 270 may be variously configured, as long as the second lower sensor 260 and the third lower sensor 270 can sense a relative distance from the floor surface B. Each of the second lower sensor 260 and the third lower sensor 270 may have a substantially similar configuration as the above-described configuration of first lower sensor 250, except for the position thereof.

A second sensor hole 261 and a second sensor recess 262 may be formed in the body 100 at a position corresponding to the second lower sensor 260. Additionally, a second bumper recess 263 may be formed in the bumper 190, and the second sensor hole 261, the second sensor recess 262, and the second bumper recess 263 may have configurations similar to the above-described first sensor hole 251, the first sensor recess 252, and the first bumper recess 253. Further, the relationship between the second lower sensor 260, the second sensor hole 261, the second sensor recess 262, and the second bumper recess 263 may correspond to the relationship between the first lower sensor 250, the first sensor hole 251, the first sensor recess 252, and the first bumper recess 253.

Similarly, a third lower sensor hole 271 and a third lower sensor recess 272 may be formed in the body 100 at a position corresponding to the third lower sensor 270, and a third bumper recess 273 may be formed in the bumper 190. The third lower sensor hole 271, the third lower sensor recess 272, and the third bumper recess 273 may have similar configurations to the above-described first sensor hole 251, the first sensor recess 252, and the first bumper recess 253. Further, the relationship between the third lower sensor 270, the third lower sensor hole 271, the third lower sensor recess 272, and the third bumper recess 273 may correspond to the relationship between the first lower sensor 250, the first sensor hole 251, the first sensor recess 252, and the first bumper recess 253.

The robot cleaner 1 according to an embodiment of the present disclosure may be configured such that the operation of the robot cleaner 1 is controlled depending on a distance sensed by the second lower sensor 260 (e.g., when a left side cliff is detected). In more detail, the rotation of one or more of the first rotating plate 10 and the second rotating plate 20 may be controlled depending on the distance sensed by the second lower sensor 260. For example, when the distance sensed by the second lower sensor 260 exceeds a predetermined value or deviates from a predetermined range, rotation of the first rotating plate 10 and the second rotating plate 20 may be stopped and operation of the robot cleaner 1 may consequently be stopped, or the rotating direction of the first rotating plate 10 and/or the second rotating plate 20 may be changed and the moving direction of the robot cleaner 1 may be changed.

Additionally, the robot cleaner 1 according to an embodiment of the present disclosure may be configured such that the operation of the robot cleaner 1 is controlled depending on a distance sensed by the third lower sensor 270 (e.g., when a right side cliff is detected). In more detail, the rotation of one or more of the first rotating plate 10 and the second rotating plate 20 may be controlled depending on the distance sensed by the third lower sensor 270. For example, when the distance sensed by the third lower sensor 270 exceeds a predetermined value or deviates from a predetermined range, rotation of the first rotating plate 10 and the second rotating plate 20 may be stopped and operation of the robot cleaner 1 may consequently be stopped, or the rotating direction of the first rotating plate 10 and/or the second rotating plate 20 may be changed and the moving direction of the robot cleaner 1 may be changed.

The distance from the connection line L1 to the second lower sensor 260 and the distance from the connection line L1 to the third lower sensor 270 may be shorter than the distance from the connection line L1 to the first support wheel 120 and the distance from the connection line L1 to the second support wheel 130 (e.g., the lower sensors 260, 270 may be positioned closer to the line L1 in a front-to-rear direction than the wheels 120, 130). Further, the second lower sensor 260 and the third lower sensor 270 may be located outside the rectangular vertical area A formed using the center of the first rotating plate 10, the center of the second rotating plate 20, the center of the first support wheel 120, and the center of the second support wheel 130 as the vertices (e.g., the lower sensors 260, 270 may be positioned farther from center line in a front-to-rear direction of the robot cleaner 1 than the wheels 120, 130).

When the second lower sensor 260 is located in the left side of the robot cleaner 1, the third lower sensor 270 may be located in the right side of the robot cleaner 1. The second lower sensor 260 and the third lower sensor 270 may be symmetrical to each other.

The robot cleaner 1 according to an embodiment of the preset disclosure may turn, such as when performing cleaning or to avoid an obstacle. In this case, the first mop 30, the second mop 40, the first support wheel 120, and the second support wheel 130 may contact the floor and support the load of the robot cleaner 1.

For example, when a cliff F is located at the left side of the robot cleaner 1 and the robot cleaner 1 changes direction leftwards or turns leftwards, sensing of the cliff F by the second lower sensor 260 may be performed before the first support wheel 120 or the second support wheel 130 reach the cliff F. When the second lower sensor 260 senses the cliff F, the load of the robot cleaner 1 may be supported by each of the first mop 30, the second mop 40, the first support wheel 120, and the second support wheel 130 (see FIG. 9B).

When a cliff F is located at the right side of the robot cleaner 1 and the robot cleaner 1 changes direction rightwards or turns rightwards, sensing of the cliff F by the third lower sensor 270 may be performed before the first support wheel 120 or the second support wheel 130 enters the cliff F. When the third lower sensor 270 senses the cliff F, the load of the robot cleaner 1 may be supported by each of the first mop 30, the second mop 40, the first support wheel 120, and the second support wheel 130 (see FIG. 9C). As described above, the robot cleaner 1 according to an embodiment of the present disclosure may prevent the robot cleaner 1 from falling off a cliff F and losing its balance when the robot cleaner 1 changes direction or is rotated in one direction.

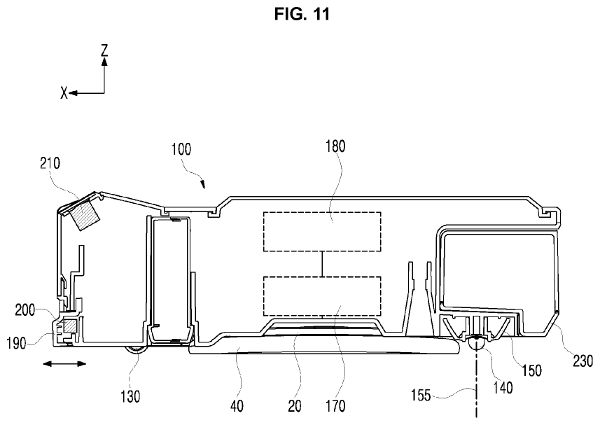

FIG. 11 is a cross-sectional diagram schematically illustrating a robot cleaner 1 and elements thereof according to an embodiment of the present disclosure. The robot cleaner 1 according to an embodiment of the present disclosure may include a controller (or control circuitry) 180, a bumper 190, a first sensor (or movement sensor) 200, and a second sensor (or obstacle sensor) 210.

The controller 180 may be configured to control the operation of a first actuator 160 and a second actuator 170 based on received information, stored information, and/or real-time collected information. In order to execute control by the controller 180, the robot cleaner 1 may include a storage medium (or memory) in which applications are stored. The controller 180 may be configured to control the robot cleaner 1 by executing the applications based on instructions inputted to the cleaner 1 and information collected, received, or otherwise acquired by the robot cleaner 1.

The bumper 190 may be coupled to the body 100 along at least a portion of the edge of the body 100 (e.g., a front edge) so as to move relative to the body 100. For example, the bumper 190 may be coupled to the body 100 so as to reciprocate in a direction approaching the center of the body 100. The bumper 190 may be coupled to the body 100 along a portion of the edge of the body 100, or coupled to the body 100 along the entire edge of the body 100.

In the robot cleaner 1 according to an embodiment of the present disclosure, the height of the lowermost portion of the body 100 located at one side of a connection line at which the bumper 190 is located may be higher than or equal to the height of the lowermost portion of the bumper 190. That is, the height of the lowermost portion of the bumper 190 from floor surface B may be lower than or equal to the height of the lowermost portion of the body 100 from floor surface B. Thereby, an obstacle which is comparatively low in height may collide with the bumper 190 and be sensed by the bumper 190 before contacting a bottom surface of the body 100.

The first sensor 200 may be coupled to the body 100, and be configured to sense movement (relative movement) of the bumper 190 relative to the body 100. The first sensor 200 may include, for example, a microswitch, a photo interrupter, or a tact switch. In another example, the first sensor may include an inertia sensor to detect a movement or contact to the bumper 190. Multiple first sensors 200 may be provided in the robot cleaner 1, and different first sensors 200 may detect movements of respective different portions of the bumper 190. For example, the robot cleaner 1 may include front, left and right first sensors 200 to detect movements of corresponding front, left, and right portions of the bumper 190.

The controller 180 may control the operation and/or operation of the robot cleaner 1 so as to avoid an obstacle when the bumper 190 of the robot cleaner 1 comes into contact with the obstacle. For example, the controller 180 may control the operation, rotational speed, rotational direction, torque, etc. of the first actuator 160 and/or the second actuator 170 based on information sensed by the first sensor 200. For example, when the bumper 190 comes into contact with an obstacle during traveling of the robot cleaner 1, the first sensor 200 may detect a position of the obstacle which the bumper 190 contacts, and the controller 180 may control the operation of the first actuator 160 and/or the second actuator 170 so as to avoid or minimize a collision force with such a contact position.

The second sensor 210 may be coupled to the body 100, and be configured to sense a relative distance from an obstacle. The second sensor 210 may be a distance sensor, such as a LIDAR sensor. For example, the second sensor may emit electromagnetic energy (e.g., visible light, infrared, or radio waves) and detect reflections of the emissions. Based on information sensed by the second sensor 210, for example, when a distance between the robot cleaner 1 and the obstacle is a predetermined value or less, the controller 180 may control the operation of the first actuator 160 and the second actuator 170 so as to change the driving direction of the robot cleaner 1 or to move the robot cleaner 1 away from the obstacle. In another example, the controller 180 may control the amounts or relatively amounts of liquid supplied to the mops 30, 40, such as to provide more liquid to one of the mops 30, 40 to cause the mops 30, 40 to have different friction forces. In yet another example, the controller 180 may change one or more of the tilt angles of the first and second plates 10, 20 to change a friction force applied by the mops 30, 40.

Further, the controller 180 may control the operation of the first actuator 160 and the second actuator 170 so as to stop the operation of the robot cleaner 1 or to change the driving direction of the robot cleaner 1 based on a distance sensed by a first lower sensor 250, a second lower sensor 260, or a third lower sensor 270. For example, the controller 180 may control the operation of the first actuator 160 and the second actuator 170 so as to change the driving direction of the robot cleaner 1 or to move the robot cleaner 1 away from a detected cliff F.

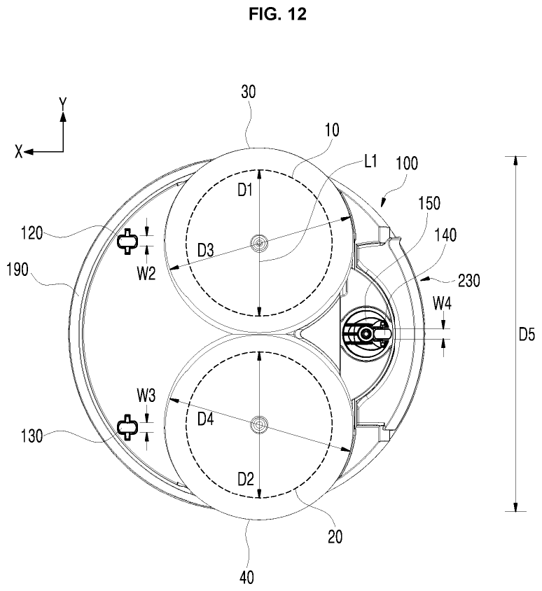

FIG. 12 is a diagram illustrating the sizes of the respective elements of the robot cleaner 1 shown in FIGS. 6A to 6C. As described above, the robot cleaner 1 according to an embodiment of the present disclosure may move (travel) due to frictional force between the first mop 30 and the floor surface B, which is generated during rotation of the first rotating plate 10, and frictional force between the second mop 40 and the floor surface B, which is generated during rotation of the second rotating plate 20.

In the robot cleaner 1 according to an embodiment of the present disclosure, the first support wheel 120 and the second support wheel 130 may be configured not to interfere with movement (traveling) of the robot cleaner 1 due to frictional force with the floor, and not to cause a load increase during movement (traveling) of the robot cleaner 1.

For this purpose, a width W2 of the first support wheel 120 and a width W3 of the second support wheel 130 may be smaller by a sufficient degree than a diameter D1 of the first rotating plate 10 or a diameter D2 of the second rotating plate 20. In more detail, the width W2 of the first support wheel 120 and the width W3 of the second support wheel 130 may be less than 1/10 of the diameter D1 of the first rotating plate 10 or the diameter D2 of the second rotating plate 20. Further, each of the diameter D1 of the first rotating plate 10 and the diameter D2 of the second rotating plate 20 may be greater than ⅓ and less than ½ of a diameter D5 of the body 100, and each of a diameter D3 of the first mop 30 and a diameter D4 of the second mop 40 may be greater than ⅓ and less than ⅔ of the diameter D5 of the body 100.

As such, even when the robot cleaner 1 is driven under the condition that the first support wheel 120 and the second support wheel 130 are in contact with the floor together with the first mop 30 and the second mop 40, the frictional force between the first support wheel 120 and the floor surface B and the frictional force between the second support wheel 130 and the floor surface B may be significantly smaller than the frictional force between the first mop 30 and the floor surface B and frictional force between the second mop 40 and the floor surface B, thereby avoiding unnecessary power loss and not interfering with movement of the robot cleaner 1.

In the robot cleaner 1 according to an embodiment of the present disclosure, a horizontal distance C1 between the center of the first support wheel 120 and the center of the second support wheel 130 may be the same as or similar to a horizontal distance C2 between the center of rotation of the first rotating plate 10 and the center of rotation of the second rotating plate 20 (see FIG. 5A) (e.g. along line L1). The horizontal distance C1 between the center of the first support wheel 120 and the center of the second support wheel 130 may be greater than a value obtained by multiplying the horizontal distance C2 by 0.8 and less than a value obtained by multiplying the horizontal distance C2 by 1.2. Therefore, the robot cleaner 1 according to an embodiment of the present disclosure may be stably supported at four points by the first support wheel 120, the second support wheel 130, the first mop 30, and the second mop 40.

In the robot cleaner 1 according to an embodiment of the present disclosure, the rotation axis 125 of the first support wheel 120 and the rotation axis 135 of the second support wheel 130 may be parallel to the connection line L1. That is, the positions of the rotation axis 125 of the first support wheel 120 and the rotation axis 135 of the second support wheel 130 on the body 100 may be fixed (fixed in the lateral direction).

The first support wheel 120 and the second support wheel 130, together with the mop 30 and the second mop 40, may be in contact with the floor, and in this case, in order to perform the rectilinear movement of the robot cleaner 1, the first mop 30 and the second mop 40 may be rotated at the same speed in opposite directions, and the first support wheel 120 and the second support wheel 130 assist the forward and backward rectilinear movement of the robot cleaner 1.

The robot cleaner 1 according to an embodiment of the present disclosure may include an auxiliary wheel body 150. Here, the auxiliary wheel body 150 may be rotatably coupled to the lower portion of the body 100, and the auxiliary wheel 140 is rotatably coupled to the auxiliary wheel body 150. That is, the auxiliary wheel 140 is coupled to the body 100 by the auxiliary wheel body 150.

The rotation axis 145 of the auxiliary wheel 140 and a rotation axis 155 of the auxiliary wheel body 150 may intersect each other, and the direction of the rotation axis 145 of the auxiliary wheel 140 and the direction of the rotation axis 155 of the auxiliary wheel body 150 may be orthogonal to each other. For example, the rotation axis 155 of the auxiliary wheel body 150 may be oriented in the vertical direction or a direction slightly inclined relative to the vertical direction, and the rotation axis 145 of the auxiliary wheel 140 may be oriented in the horizontal direction.

In the robot cleaner 1 according to an embodiment of the present disclosure, the auxiliary wheel 140 comes into contact with the floor surface B when the robot cleaner 1 is not being used (in the state in which the first mop 30 and the second mop 40 are separated from the robot cleaner 1), and in this state, when a user desires to move the robot cleaner 1, the direction in which the auxiliary wheel 140 is oriented may be freely changed by the auxiliary wheel body 150, and thus, the robot cleaner 1 may be easily moved.

An aspect of the present disclosure is to provide a robot cleaner including a pair of mops that rotate while contacting a floor and a pair of wheels supporting the robot cleaner, which is thus capable of avoiding a cliff before the wheels enter the cliff. Another aspect of the present disclosure is to provide a robot cleaner which is stably supported by a pair of wheels, and which is capable of effectively sensing a cliff using sensors without restriction or interfere due to the wheels. Still another aspect of the present disclosure is to provide a robot cleaner capable of avoiding a cliff before wheels thereof enter the cliff, during rectilinear movement, turning, or curvilinear movement of the robot cleaner. Yet another aspect of the present disclosure is to provide a robot cleaner capable of effectively sensing a cliff around wheels thereof. Still another aspect of the present disclosure is to provide a robot cleaner capable of effectively sensing whether or not the robot cleaner has contacted an obstacle located on a floor surface and effectively sensing a cliff, simultaneously.

A robot cleaner according to an embodiment of the present disclosure includes a body, a first mop, and a second mop. The robot cleaner may be configured to autonomously move without application of a separate external force. That is, the robot cleaner may be configured to move like a conventional robot cleaner. The body may form the overall exterior of the robot cleaner, or be formed as a frame to which other elements of the robot cleaner are coupled. The first mop may be configured to mop a floor while coming into surface contact with the floor, and be rotatably coupled to the body. The second mop may be configured to mop the floor while coming into surface contact with the floor, be spaced apart from the first mop, and be rotatably coupled to the body.

The robot cleaner may further include a first rotating plate and a second rotating plate. The first mop may be rotatably coupled to the body by the first rotating plate, and the second mop may be rotatably coupled to the body by the second rotating plate. Each of the first rotating plate and the second rotating plate may be rotatably coupled to the body. The first rotating plate may be coupled to the lower portion of the body, and the second rotating plate may also be coupled to the lower portion of the body.

The first mop may be configured to be detachably attached to a bottom surface of the first rotating plate, and may be coupled to the first rotating plate so as to be rotated together with the first rotating plate. When the robot cleaner is operated, the first mop may face the floor. The second mop may be configured to be detachably attached to the bottom surface of the second rotating plate, and the second mop may be coupled to the second rotating plate so as to be rotated together with the second rotating plate. When the robot cleaner is operated, the second mop may face the floor. The robot cleaner may further include a first support wheel and a second support wheel. The first support wheel and the second support wheel may be configured to contact the floor surface so as to support the robot cleaner.

In order to prevent the robot cleaner from falling off a cliff, the robot cleaner may further include a first lower sensor. The first lower sensor may be provided in the lower portion of the body, and be configured to sense a relative distance from the floor. The first lower sensor may include an optical sensor including a light emitter configured to emit light and a light receiver configured to receive reflected light which is incident thereon. The first lower sensor may include an infrared sensor.

In the robot cleaner, the first support wheel, the second support wheel, and the first lower sensor may be located at the same side of a virtual connection line connecting the center of the first rotating plate and the center of the second rotating plate. In the robot cleaner, the first lower sensor may be located between the first support wheel and the second support wheel along an edge of the body, and may be located further away from the connection line than the first support wheel and the second support wheel, so that, when the robot cleaner moves rectilinearly or turns around, sensing of a cliff by the first lower sensor may be performed before the robot cleaner enters the cliff.

In the robot cleaner, the rotation of one or more of the first rotating plate and the second rotating plate may be controlled depending on the distance sensed by the first lower sensor. In the robot cleaner, a sensing direction of the first lower sensor may be inclined downwards towards the edge of the body, so as to rapidly sense a cliff located in front of the robot cleaner in the moving direction of the robot cleaner.

In the robot cleaner, a distance from the center of the first rotating plate to the first support wheel may be correspond to a distance from the center of the second rotating plate to the second support wheel. In the robot cleaner, the first support wheel may be located closer to the first rotating plate than the second rotating plate, the second support wheel may be located closer to the second rotating plate than the first rotating plate. When a horizontal distance between the center of the first support wheel and the center of the second support wheel is L1 and a horizontal distance between the center of rotation of the first rotating plate and the center of rotation of the second rotating plate is L2, L2 may be greater than 0.8×L2 and less than 1.2×L2.

In the robot cleaner, the first rotating plate and the second rotating plate may be symmetrical to each other, and the first support wheel and the second support wheel may be symmetrical to each other. A rotation axis of the first support wheel and a rotation axis of the second support wheel may be parallel to the connection line.

The center of gravity of the robot cleaner may be located inside a rectangular vertical area formed using the center of the first rotating plate, the center of the second rotating plate, the center of the first support wheel, and the center of the second support wheel as respective vertices. The robot cleaner may be supported at four points by the first mop, the second mop, the first support wheel, and the second support wheel. The first lower sensor may be located between the first support wheel and the second support wheel.

The robot cleaner may further include a second lower sensor and a third lower sensor. The second lower sensor and the third lower sensor may be provided in the lower portion of the body at the side of the connection line at which the first support wheel and the second support wheel are located, so as to sense a relative distance from the floor. Each of the second lower sensor and the third lower sensor may include an optical sensor including a light emitter configured to emit light and a light receiver configured to receive reflected light which is incident thereon. Each of the second lower sensor and the third lower sensor may include an infrared sensor. The second lower sensor may be located at one side of the first support wheel opposite to a remaining side thereof at which the first lower sensor is located. The third lower sensor may be located at one side of the second support wheel opposite to a remaining side thereof at which the first lower sensor is located.

In the robot cleaner, rotation of one or more of the first rotating plate and the second rotating plate may be controlled depending on the distance sensed by the second lower sensor or the third lower sensor. The second lower sensor and the third lower sensor may be located outside the rectangular vertical area formed using the center of the first rotating plate, the center of the second rotating plate, the center of the first support wheel, and the center of the second support wheel as the respective vertices. A distance from the connection line to the second lower sensor and a distance from the connection line to the third lower sensor may be less than a distance from the connection line to the first support wheel and a distance from the connection line to the second support wheel.

The robot cleaner may further include a first actuator, a second actuator, and a controller. The first actuator may be coupled to the body and be configured to rotate the first rotating plate. The second actuator may be coupled to the body and be configured to rotate the second rotating plate. The controller may be configured to control operation of one or more of the first actuator and the second actuator based on the distance sensed by the first lower sensor.

The robot cleaner may further include a bumper and a first sensor. The bumper may be coupled to the side of the body at which the first lower sensor is located, and may be coupled along the edge of the body, so as to move relative to the body. The first sensor may be coupled to the body so as to sense movement of the bumper relative to the body.

The controller may control operation of one or more of the first actuator and the second actuator based on information acquired by the first sensor. In the robot cleaner, the rotation of one or more of the first rotating plate and the second rotating plate may be controlled based on the information acquired by the first sensor. The height of the lowermost portion of the body at the side of the connection line at which the bumper is located may be higher than or equal to the height of the lowermost portion of the bumper.

In the robot cleaner, a first sensor hole configured to expose the first lower sensor may be provided in the bottom surface of the body. The first sensor hole may be formed to be inclined downwards towards the edge of the body. A first sensor recess configured to be connected to the first sensor hole may be formed in the bottom surface of the body. A first bumper recess configured to be connected to the first sensor recess may be formed in the bottom surface of the bumper. The first sensor hole, the first sensor recess, and the first bumper recess may be arranged in a radial direction of the body.

A robot cleaner according to embodiments of the present disclosure includes a first mop and a second mop which contact a floor and rotate, and a first support wheel and a second support wheel which support the robot cleaner. The robot cleaner is moved and supported by the first mop, the second mop, the first support wheel, and the second support wheel. A first lower sensor is located between the first support wheel and the second support wheel along the edge of the body, and is located further away from a connection line than the first support wheel and the second support wheel. As such, the robot cleaner according to the embodiment of the present disclosure can effectively sense a cliff during turning or curvilinear movement as well as rectilinear movement (forward movement), and effectively avoid the cliff before the first support wheel and the second support wheel enter the cliff.

The robot cleaner according to the embodiments of the present disclosure includes a second lower sensor and a third lower sensor in addition to the first lower sensor. A distance from the connection line to the second lower sensor and a distance from the connection line to the third lower sensor are shorter than a distance from the connection line to the first support wheel and a distance from the connection line to the second support wheel. The second lower sensor and the third lower sensor are located outside a rectangular vertical area formed using the center of the first rotating plate, the center of the second rotating plate, the center of the first support wheel, and the center of the second support wheel as the respective vertices. Thereby, during forward movement, turning, and curvilinear movement of the robot cleaner, sensing of a cliff by the first lower sensor, the second lower sensor, and the third lower sensor is not restricted or interfered with by the first support wheel and the second support wheel, and thus the robot cleaner can effectively avoid the cliff.

In the robot cleaner according to the embodiments of the present disclosure, the second lower sensor is located at one side of the first support wheel opposite to the other side thereof at which the first lower sensor is located, and the third lower sensor is located at one side of the second support wheel opposite to the other side thereof at which the first lower sensor is located. Accordingly, the robot cleaner can effectively sense cliffs located around the first support wheel and the second support wheel.

The robot cleaner according to the embodiments of the present disclosure includes a bumper and a first sensor, and a first sensor hole for accommodating the first lower sensor is formed to be inclined downwards towards the edge of the body. Therefore, the robot cleaner can effectively sense whether or not the robot cleaner has contacted an obstacle located on the floor through the bumper and the first sensor, and effectively sense a cliff through the first lower sensor.

In certain examples, a robot cleaner comprises: a body; a first rotating plate having a lower surface to which a first mop is coupled so as to face a floor, the first rotating plate being rotatably coupled to the body; a second rotating plate having a lower surface to which a second mop is coupled so as to face the floor, the second rotating plate being rotatably coupled to the body; a first wheel and a second wheel spaced apart from the first mop and the second mop and coupled to the body; and a first sensor provided so as to sense a first distance from the floor, wherein the first wheel, the second wheel, and the first sensor are located at a common side of the body with respect to a connection line extending between a center of rotation of the first rotating plate and a center of rotation of the second rotating plate, and wherein the first sensor is located closer to a center line of the body in a left-to-right direction than the first wheel and the second wheel, and is located farther from the connection line in a front-to-rear direction than the first wheel and the second wheel.

Rotation of one or more of the first rotating plate or the second rotating plate is controlled based on the first distance sensed by the first sensor. A sensing direction of the first sensor is inclined downwards and towards an edge of the body. A distance from the center of rotation of the first rotating plate to the first wheel corresponds to a distance from the center of rotation of the second rotating plate to the second wheel.

The first wheel may be located closer to the first rotating plate than to the second rotating plate, the second wheel may be located closer to the second rotating plate than to the first rotating plate, and a first horizontal distance between a center of the first wheel and a center of the second wheel may be in a range of 0.8 to 1.2 times a second horizontal distance between the center of rotation of the first rotating plate and the center of rotation of the second rotating plate.

The first rotating plate and the second rotating plate may be symmetrical to each other with respect to the center line of the body in the left-to-right direction, and the first wheel and the second wheel may be symmetrical to each other with respect to the center line of the body in the left-to-right direction. A rotation axis of the first wheel and a rotation axis of the second wheel may be parallel to the connection line.

A center of gravity of the robot cleaner may be located inside a rectangular area formed using the center of rotation of the first rotating plate, the center of rotation of the second rotating plate, the first wheel, and the second wheel as respective vertices. The robot cleaner may be supported at four points by the first mop, the second mop, the first wheel, and the second wheel when moving.

The robot cleaner may further comprise: a second sensor provided to sense a second distance from the floor; and a third sensor provided so as to sense a third distance from the floor, wherein the second sensor is located at a first side of the first wheel and the first sensor is located at a second side of the first wheel, and wherein the third lower sensor is located at a first side of the second wheel and the first sensor is located at a second side of the second wheel.

The robot cleaner may further comprise: a second sensor and a third sensor provided at the side of the body with respect to the connection line where the first and second wheels and the first sensor are located so as to sense respective distances from the floor, wherein rotation of one or more of the first rotating plate or the second rotating plate is controlled further based on at least one of the distances sensed by the second sensor and the third sensor, and wherein the second sensor and the third sensor are located outside a rectangular area formed using the center of rotation of the first rotating plate, the center of rotation of the second rotating plate, the first wheel, and the second wheel as respective vertices. Respective distances from the connection line to the second sensor and the third lower sensor in the front-to-rear direction may be less than respective distances from the connection line to the first wheel and the second wheel in the front-to-rear direction.

The robot cleaner may further comprise: a first actuator coupled to the body and configured to rotate the first rotating plate; a second actuator coupled to the body and configured to rotate the second rotating plate; and a controller configured to control operation of one or more of the first actuator or the second actuator based on the first distance sensed by the first sensor. The robot cleaner may further comprise: a bumper coupled to the body along an edge of the body at the side of the connection line at which the first sensor is located, so as to move relative to the body; and a movement sensor coupled to the body so as to sense movement of the bumper relative to the body, wherein the controller controls operation of one or more of the first actuator or the second actuator further based on the movement of the bumper relative to the body sensed by the movement sensor.

The robot cleaner may further comprise: a bumper coupled to the body along an edge of the body at the side of the connection line at which the first sensor is located, so as to move relative to the body; and a movement sensor coupled to the body so as to sense movement of the bumper relative to the body, wherein rotation of one or more of the first rotating plate or the second rotating plate is controlled further based on the movement of the bumper relative to the body sensed by the movement sensor, and wherein a height of a lowermost section of the body at the side of the connection line at which the bumper is located is greater than or equal to a height of a lowermost portion of the bumper.

A first sensor hole configured to expose the first sensor may be provided in the lower surface of the body; and the first sensor hole may be inclined downwards and towards the edge of the body. A first sensor recess may be configured to be connected to the first sensor hole is formed in the bottom surface of the body; a first bumper recess may be configured to be connected to the first sensor recess is formed in a bottom surface of the bumper; and the first sensor hole, the first sensor recess, and the first bumper recess may be provided in a radial direction of the body.

In certain implementations, a robot cleaner may comprise: a body; a first mop and a second mop rotatably coupled to the body so as to contact and clean a floor; a first wheel coupled to a lower surface of the body in front of the first mop; a second wheel coupled to the lower surface of the body in front of the second mop; and a cliff sensor positioned closer to a front of the body and closer to a center line of the body in a left-to-right direction than the first wheel and the second wheel, wherein rotation of one or more of the first mop or the second mop is controlled based on whether the cliff sensor detects a cliff.

In certain implementations, a robot cleaner may comprise: a body; a first rotating plate and a second rotating plate rotatably coupled to a lower surface of the body; a first mop detachably attached to a lower surface of the first rotating plate; a second mop detachably attached to a lower surface of the second rotating plate; a first wheel coupled to the lower surface of the body in front of the first mop; a second wheel coupled to the lower surface of the body and positioned in front of the second mop; and a first cliff sensor located in a region of the lower surface of the body that at least partially extends between the first wheel and the second wheel, the first cliff sensor being provided further forward than the first wheel and the second wheel, wherein rotation of one or more of the first rotating plate or the second rotating plate is controlled depending on whether the first cliff sensor detects a cliff.

The robot cleaner may further comprise: a second cliff sensor provided in the lower surface of the body and in front of the first mop; and a third cliff sensor provided in the lower surface of the body and in front of the second mop, wherein the second cliff sensor, the first wheel, the first cliff sensor, the second wheel, and the third cliff sensor are sequentially provided along an edge of the body.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A robot cleaner comprising:
a body;
a first rotating plate rotatably coupled to the body and having a lower surface configured to receive a first mop;
a second rotating plate rotatably coupled to the body and having a lower surface configured to receive a second mop;
at least one wheel spaced apart from the first mop and the second mop and coupled to the body; and
a first sensor provided so as to sense a first distance from the floor,
wherein the at least one wheel and the first sensor are located in front of the first rotating plate and the second rotating plate, and
wherein the first sensor is located forward of the at least one wheel.

2. The robot cleaner of claim 1, wherein rotation of one or more of the first rotating plate or the second rotating plate is controlled based on the first distance sensed by the first sensor.

3. The robot cleaner of claim 1, wherein a sensing direction of the first sensor is inclined downwards and towards an edge of the body.

4. The robot cleaner of claim 1, wherein the at least one wheel includes a first wheel and a second wheel, and
wherein the first sensor is located closer in a region extending between the first wheel and the second wheel in a front-to-back direction.

5. The robot cleaner of claim 4, wherein a distance from a center of the first rotating plate to the first wheel corresponds to a distance from a center of the second rotating plate to the second wheel.

6. The robot cleaner of claim 4, wherein:
the first wheel is located closer to the first rotating plate than to the second rotating plate,
the second wheel is located closer to the second rotating plate than to the first rotating plate, and
a first horizontal distance between a center of the first wheel and a center of the second wheel is in a range of 0.8 to 1.2 times a second horizontal distance between a center of rotation of the first rotating plate and a center of rotation of the second rotating plate.

7. The robot cleaner of claim 4, wherein:
the first rotating plate and the second rotating plate are symmetrical to each other with respect to the body in a left-to-right direction, and
the first wheel and the second wheel are symmetrical to each other with respect to the body in the left-to-right direction.

8. The robot cleaner of claim 4, wherein a rotation axis of the first wheel and a rotation axis of the second wheel are parallel to a connection line between a center of the first rotating plate and a center of the second rotating plate.

9. The robot cleaner of claim 4, wherein a center of gravity of the robot cleaner is located inside a rectangular area formed using a center of the first rotating plate, a center of the second rotating plate, a center of the first wheel, and a center of the second wheel as respective vertices.

10. The robot cleaner of claim 1, wherein the robot cleaner is supported by the first mop, the second mop, the at least one wheel.

11. The robot cleaner of claim 4, further comprising:
a second sensor provided to sense a second distance from the floor; and
a third sensor provided to sense a third distance from the floor,
wherein the second sensor is located at a first side of the first wheel and the first sensor is located at a second side of the first wheel, and
wherein the third lower sensor is located at a first side of the second wheel and the first sensor is located at a second side of the second wheel.

12. The robot cleaner of claim 1, further comprising:
a second sensor and a third sensor provided in front of the first rotating plate and the second rotating plate so as to sense respective distances from the floor,
wherein rotation of one or more of the first rotating plate or the second rotating plate is controlled based on at least one of the distances sensed by the second sensor and the third sensor, and
wherein the second sensor and the third sensor are located outside an area formed using a center of the first rotating plate, a center of the second rotating plate, and each of the at least one wheel as respective vertices.

13. The robot cleaner of claim 12, wherein respective distances from a connection line between a center of the first rotating plate and a center of the second rotating plate to the second sensor and the third lower sensor in a front-to-rear direction are less than respective distances from the connection line to the first wheel and the second wheel in the front-to-rear direction.

14. The robot cleaner of claim 1, further comprising:
a first actuator coupled to the body and configured to rotate the first rotating plate;
a second actuator coupled to the body and configured to rotate the second rotating plate; and
a controller configured to control operation of one or more of the first actuator or the second actuator based on the first distance sensed by the first sensor.

15. The robot cleaner of claim 14, further comprising:
a bumper coupled to the body along an edge of the body at front region of the body so as to move relative to the body; and
a movement sensor coupled to the body so as to sense movement of the bumper relative to the body,
wherein the controller controls operation of one or more of the first actuator or the second actuator further based on whether the movement sensor detects movement of the bumper relative to the body.

16. The robot cleaner of claim 1, further comprising:
a bumper coupled to the body along an edge of the body at a front side of body so as to move relative to the body; and
a movement sensor coupled to the body so as to sense movement of the bumper relative to the body,
wherein rotation of one or more of the first rotating plate or the second rotating plate is controlled further based on the movement of the bumper relative to the body sensed by the movement sensor, and
wherein a height of a lowermost section of a front side the body at which the bumper is located is greater than or equal to a height of a lowermost portion of the bumper.

17. The robot cleaner of claim 16, wherein:
a first sensor hole configured to expose the first sensor is provided in the lower surface of the body; and
the first sensor hole is inclined downwards and towards the edge of the body.

18. The robot cleaner of claim 17, wherein:
a first sensor recess configured to be connected to the first sensor hole is formed in the bottom surface of the body;
a first bumper recess configured to be connected to the first sensor recess is formed in a bottom surface of the bumper; and
the first sensor hole, the first sensor recess, and the first bumper recess are provided in a radial direction of the body.

19. A robot cleaner comprising:
a body;
a first mop and a second mop rotatably coupled to the body so as to contact and clean a floor;
at least one wheel coupled to a lower surface of the body in front of the first mop and the second mop; and
a cliff sensor positioned closer to a front of the body than the at least one wheel,
wherein rotation of one or more of the first mop or the second mop is controlled based on whether the cliff sensor detects a cliff.

20. A robot cleaner comprising:
a body;
a first rotating plate and a second rotating plate rotatably coupled to a lower surface of the body;
a first mop configured to be detachably attached to a lower surface of the first rotating plate;
a second mop configured to be detachably attached to a lower surface of the second rotating plate;
a first wheel coupled to the lower surface of the body in front of the first mop;
a second wheel coupled to the lower surface of the body and positioned in front of the second mop; and
a first cliff sensor located in a region of the lower surface of the body that at least partially extends between the first wheel and the second wheel, the first cliff sensor being provided further forward than the first wheel and the second wheel,
wherein rotation of one or more of the first rotating plate or the second rotating plate is controlled depending on whether the first cliff sensor detects a cliff.

21. The robot cleaner of claim 20, further comprising:
a second cliff sensor provided in the lower surface of the body and in front of the first mop; and
a third cliff sensor provided in the lower surface of the body and in front of the second mop,
wherein the second cliff sensor, the first wheel, the first cliff sensor, the second wheel, and the third cliff sensor are sequentially provided along an edge of the body.
